(19) United States
(12) Patent Application Publication
(10) Pub. No.: US 2010/0083798 A1
(43) Pub. Date: Apr. 8, 2010

(54) ADUSTABLE WRENCH STRUCTURE

(76) Inventor: Daniel TAI, Lisle, IL (US)

Correspondence Address: HDLS IPR Services, PO Box 220746, Chantilly, VA, 20153, US

(21) Appl. No.: 12/565,997

(22) Filed: Sep. 24, 2009

(30) Foreign Application Priority Data
Oct. 3, 2008 (TW) 097217683

(51) Int. Cl. B25B 13/16

(52) U.S. Cl. 81/165

(57) ABSTRACT

An adjustable wrench structure includes a main body, a movable body, and an adjusting wheel. The adjusting wheel is adapted to control the movable body to move forwards or backwards with respect to the main body such that the movable body and the main body are adjusted to form a gap at the same end for screwing a nut or bolt. The adjusting wheel of is located at a rear section of the wrench so the user does not have to move his/her hand forward and backward. The adjusting wheel is fitted on outer side of the wrench to allow oversize design to screw the nut or bold easily and effortlessly.

### BACKGROUND OF THE INVENTION

1. Field of the Invention

The present invention relates to an adjustable wrench structure for screwing a bolt.

2. Description of the Prior Art

Conventional bolts or nuts are made in the form of a hexagon or a polygon in various sizes. As usual, an adjustable wrench is used to lock or unlock bolts or nuts.

A conventional adjustable wrench has a fixed part and a movable part at a front end thereof. The movable part is adjusted to a desired position by turning an adjusting wheel embedded inside at the frond end of the wrench with the thumb and index fingers of the user. It is not convenient to operate the conventional wrench because the user has to move his/her hand to the front end to adjust to the right size and move back to the rear end to turn the wrench repeatedly. In addition, the adjusting wheel is located at the front end and embedded inside of the wrench and is limited in size. It is difficult to operate the adjusting wheel, particularly, when used in a narrow and small space.

### SUMMARY OF THE INVENTION

The present invention is to provide an adjustable wrench structure which has an adjusting wheel located at a rear section so the user does not have to move his or her hand forward and backward for quick operation and the adjusting wheel is formed on outer side of the wrench so it could be turned easily and effortlessly.

Another, the present invention is to provide an adjustable wrench structure which has the adjusting wheel in the form of a ring larger in size than the conventional one to be turned easily and quickly.

According to the present invention, there is provided an adjustable wrench structure comprising a main body, a movable body, and an adjusting wheel. The movable body is movable with respect to the main body. The adjusting wheel is adapted to control the movable body to move forwards or backwards with respect to the main body. The movable body and the main body are provided with a clamping board, respectively, at the same end thereof for changing the distance between the two clamping boards.

### BRIEF DESCRIPTION OF THE DRAWINGS

FIG. 1 is an exploded view according to a first embodiment of the present invention;

FIG. 2 is a perspective view according to the first embodiment of the present invention in an operated status;

FIG. 3 is a perspective view according to the first embodiment of the present invention in use;

FIG. 4 is an exploded view according to a second embodiment of the present invention;

FIG. 5 is an exploded view according to a third embodiment of the present invention;

FIG. 6 is an exploded view according to a fourth embodiment of the present invention;

FIG. 7 is a perspective view according to the fourth embodiment of the present invention;

FIG. 8 is a perspective view of the present invention showing the wrench provided with a handle; and

FIG. 9 is a perspective view of the present invention showing a main body formed with teeth.

### DETAILED DESCRIPTION OF THE PREFERRED EMBODIMENT

Embodiments of the present invention will now be described, by way of example only, with reference to the accompanying drawings.

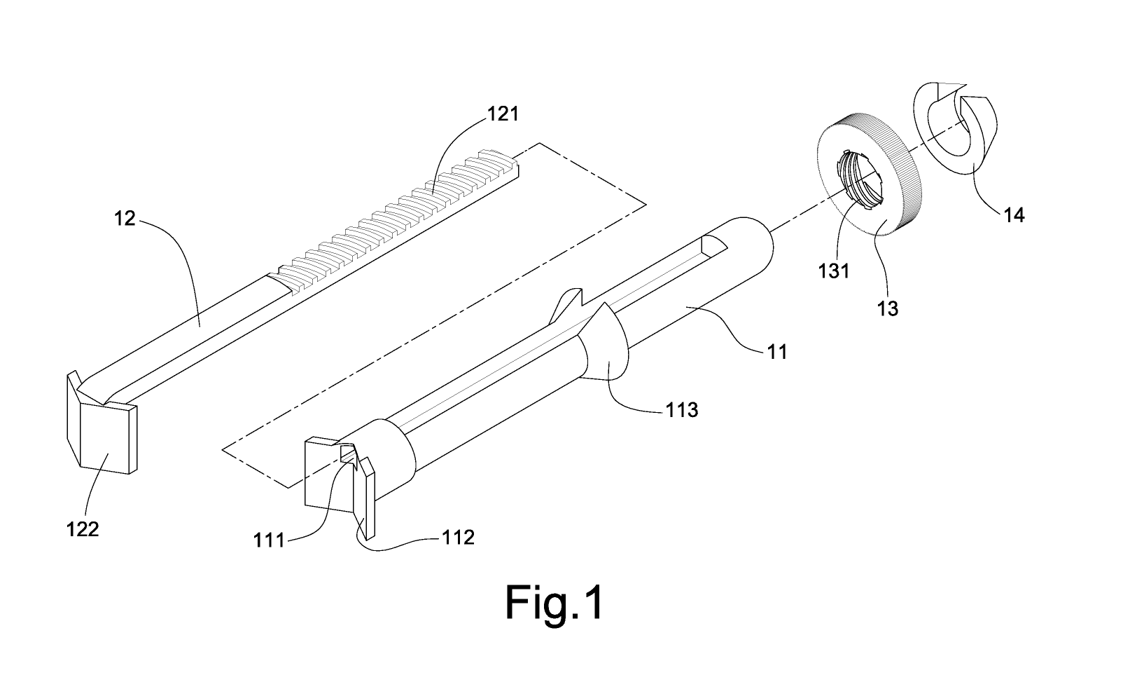

As shown in FIG. 1, an adjustable wrench structure according to a first embodiment of the present invention comprises a main body 11, a movable body 12, and an adjusting wheel 13.

The main body 11 is substantially in a bar shape having a first end and a second end. The main body 11 comprises a slide trough 111 extending from the first end towards the second end, a first clamping board 112 at the first end, and a retaining member 113 at a middle portion thereof. In this embodiment, the first clamping board 112 is in a “>”shape, but the shape of the first clamping board 112 is not limited. The retaining member 113 is substantially in an annular shape.

The movable body 12 is substantially in a strip shape having a first end and a second end. The second end of the movable body 12 is inserted into the slide trough 111 of the main body 11, and is formed with teeth 121. The first end of the movable body 12 is provided with a second clamping board 122. In this embodiment, the second clamping board 122 is in a “<”shape, but the shape of the second clamping board 122 is not limited.

The adjusting wheel 13 is formed with threads 131 therein. The adjusting wheel 13 is fitted on the main body 11 next to the retaining member 113 and positioned with a second retaining member 14. The adjusting member 13 is confined between two retaining members 113 and 14.

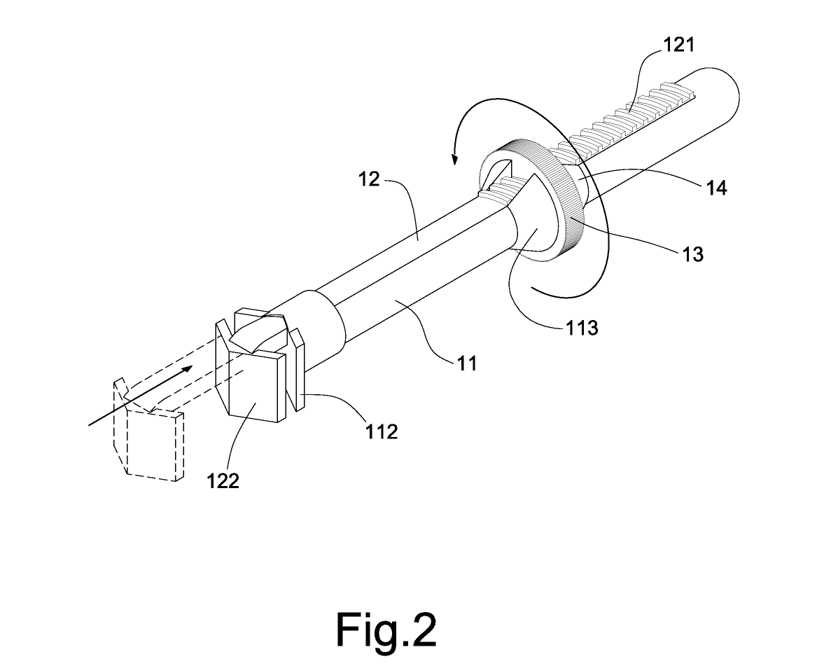

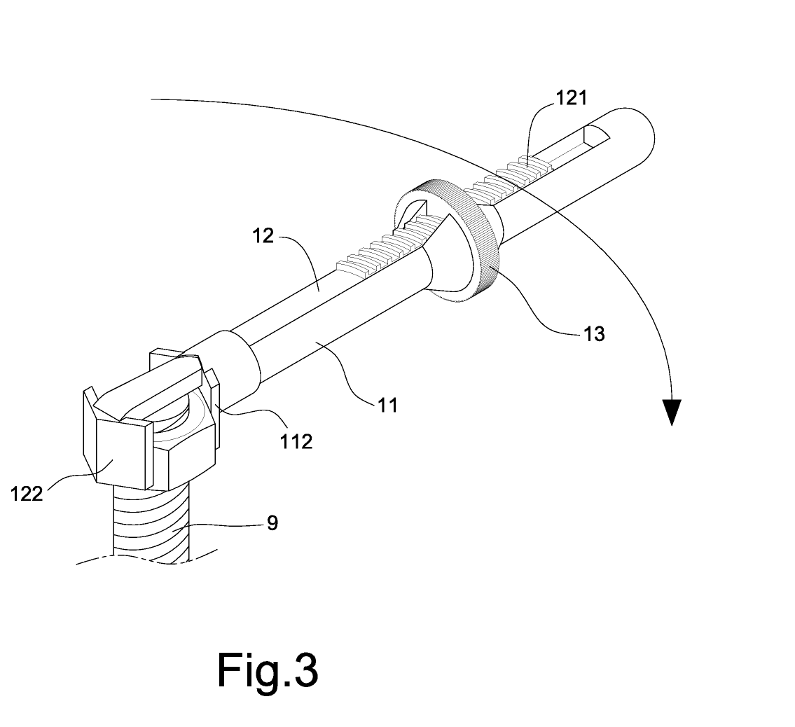

Referring to the FIGS. 1 and 2, the threads 131 of the adjusting member 13 engage with the teeth 121 of the movable body 12. When the adjusting wheel 13 is turned, the movable body 12 will be moved forwards or backwards with respect to the main body 11 via the threads 131 engaging with the teeth 121 so as to change the distance between the first clamping board 112 and the second clamping board 122 for screwing a bolt 9, as shown in FIG. 3. As shown in the drawings, the adjusting wheel 13 of the present invention is larger in size than the conventional one and is fitted on outer side of the wrench to provide a quick and effortless adjustment and ease of use.

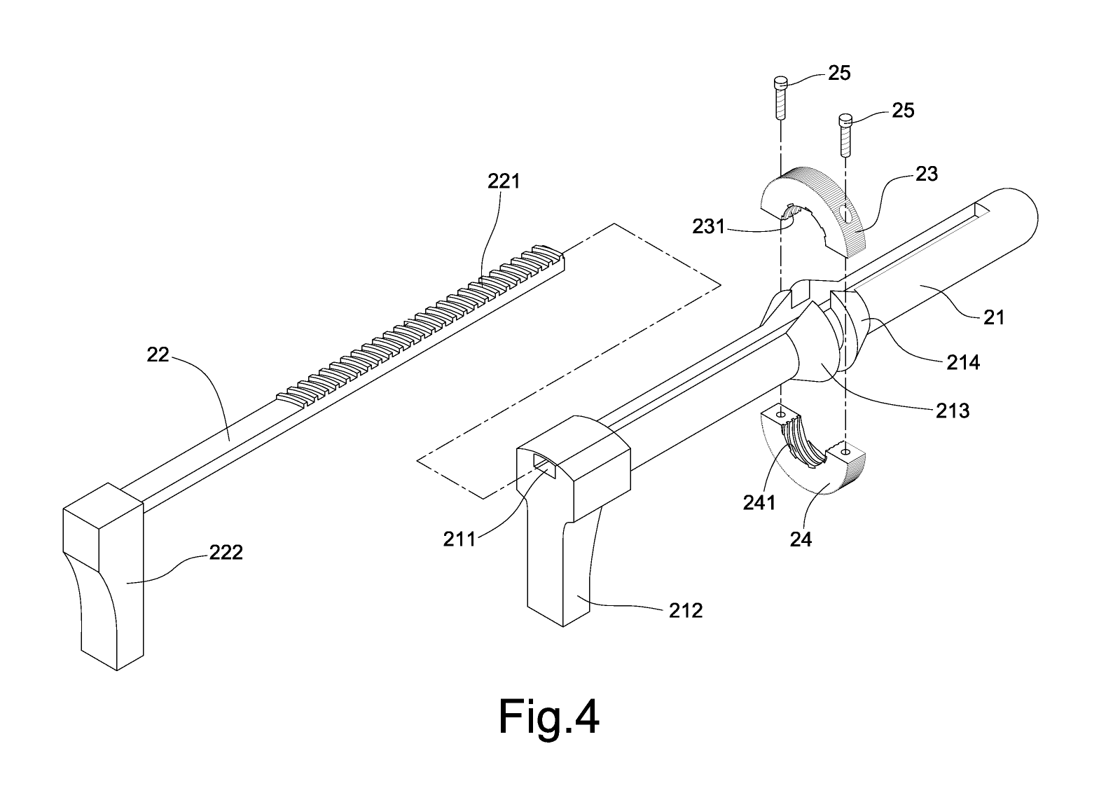

As shown in FIG. 4, an adjustable wrench structure according to a second embodiment of the present invention comprises a main body 21, a movable body 22, and a pair of adjusting members 23, 24 to form a wheel.

The main body 21 is substantially in a bar shape having a first end and a second end. The main body 21 comprises a slide trough 211 extending from the first end towards the second end, a first clamping board 212 at the first end, and a pair of retaining members 213, 214 at a middle portion thereof In this embodiment, the first clamping board 112 has a flat body. The retaining members 213, 214 are substantially in an annular shape.

The movable body 22 is substantially in a strip shape having a first end and a second end. The second end of the movable body 22 is inserted into the slide trough 211 of the main body 21, and is formed with teeth 221. The first end of the movable body 22 is provided with a second clamping board 222. In this embodiment, the second clamping board 222 has a flat body.

The adjusting members 23, 24 are semiannular rings formed with threads 231, 241 therein. The adjusting members 23, 24 are fitted on the main body 21 between the retaining members 213, 214. The adjusting members 23, 24 are assembled together with screws 25 to form an adjusting wheel.

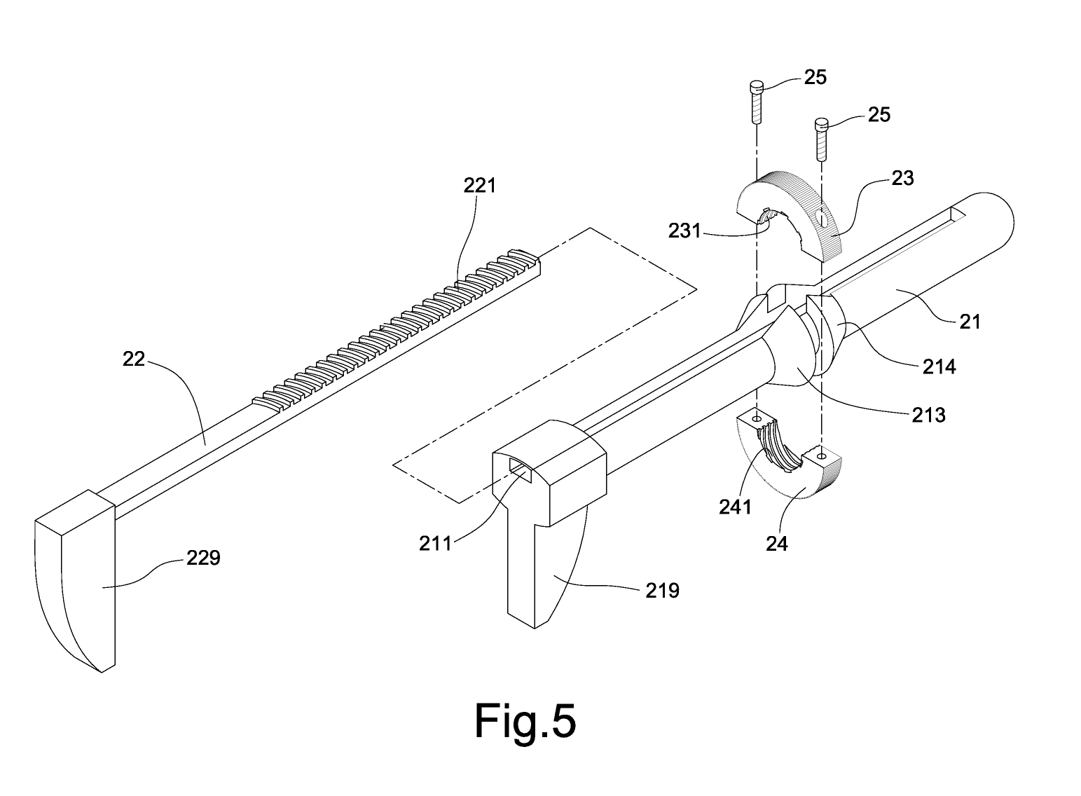

FIG. 5 shows a third embodiment of the present invention, which is substantially similar to the second embodiment with the exceptions described hereinafter. A first clamping board 219 and a second clamping board 229 are in a different shape. In other words, the first clamping board and the second clamping board of the present invention can adapt to different shapes as desired.

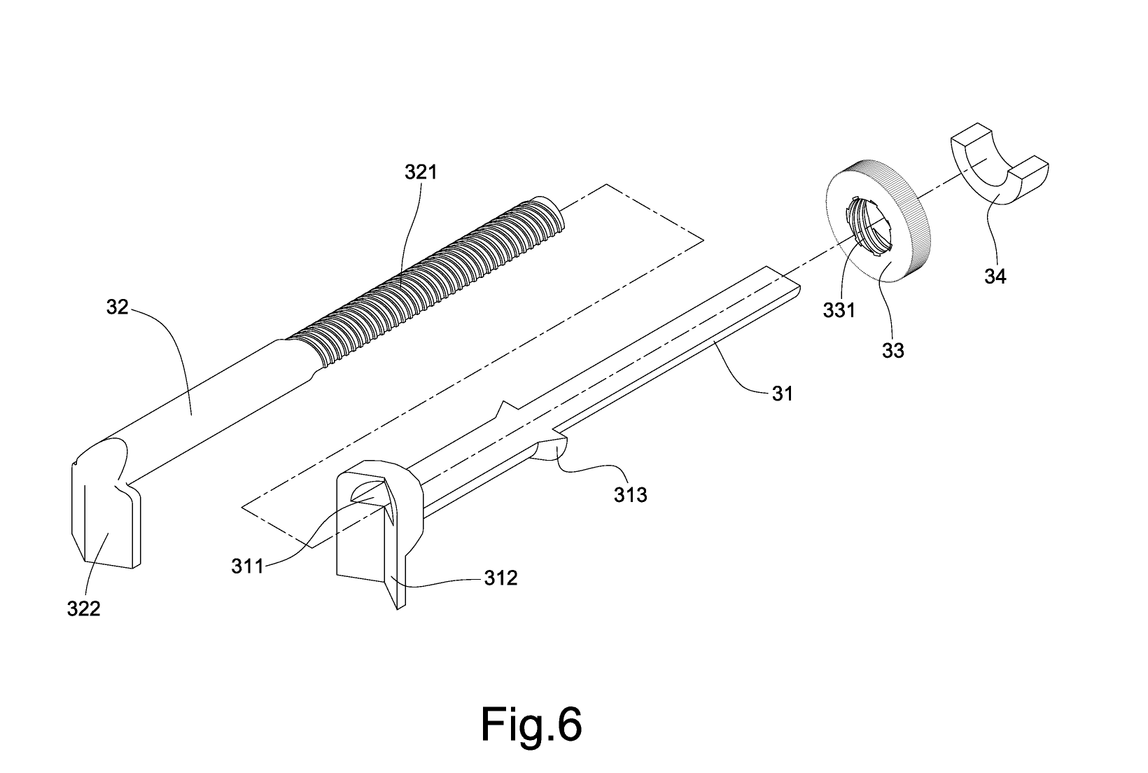

As shown in FIG. 6, an adjustable wrench structure according to a third embodiment of the present invention comprises a main body 31, a movable body 32, and an adjusting wheel 33. The main body 31 and the movable body 32 are made in the form of a semi-cylinder.

The main body 31 comprises a slide through 311 and a first clamping board 312 at one end thereof, and a retaining member 313 at a middle portion thereof. The adjusting member 33 is confined between two retaining member 313 and 34.

The movable body 32 has a first end and a second end. The second end of the movable body 32 is inserted into the slide trough 311 of the main body 31, and is formed with teeth 321. The first end of the movable body 32 is provided with a second clamping board 322.

The adjusting wheel 33 is formed with threads 331 therein.

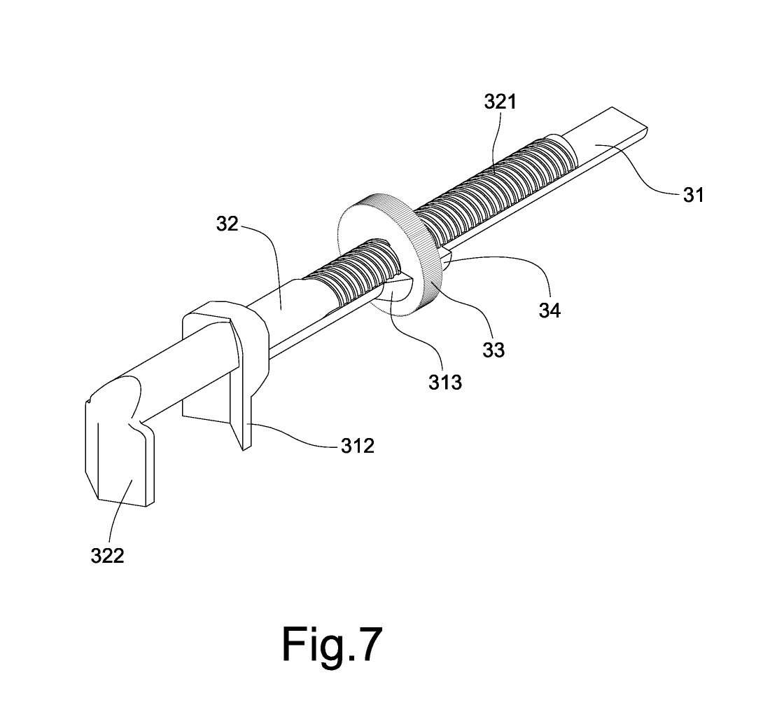

As shown in FIG. 7, when the adjusting wheel 33 is turned, the movable body 32 will be moved forwards or backwards with respect to the main body 31 to change the distance between the first clamping board 312 and the second clamping board 322.

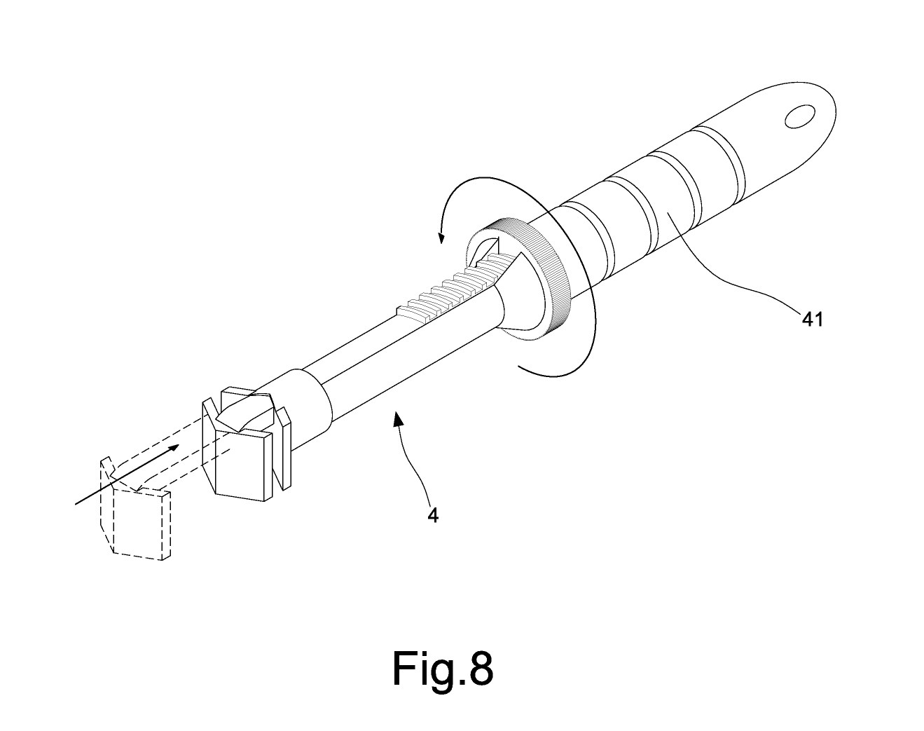

As shown in FIG. 8, a wrench 4 according to any one aforesaid embodiment of the present invention is provided with a handle 41 at a distal end thereof for grasping when in use.

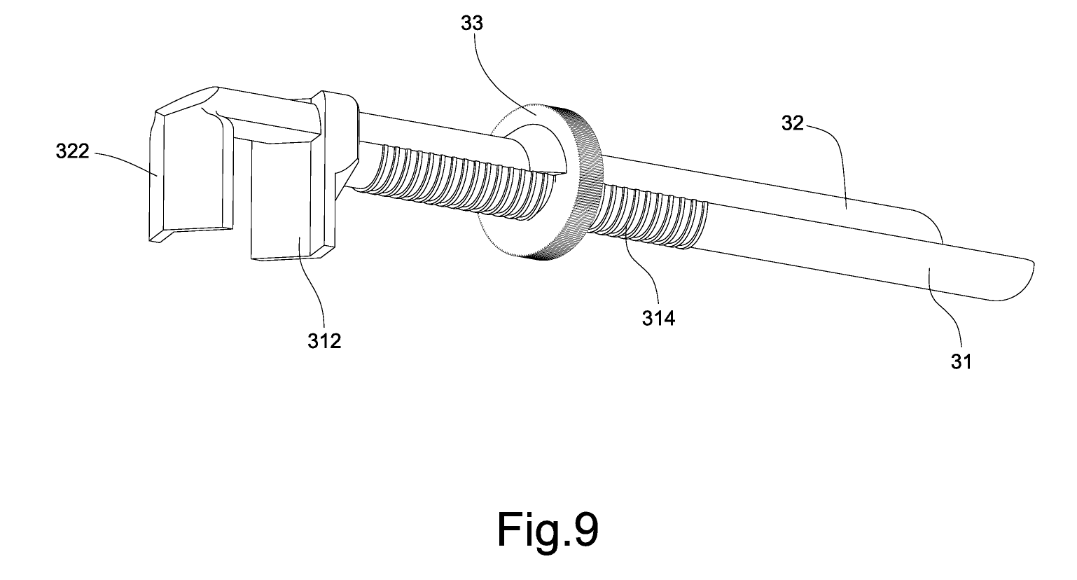

FIG. 9 shows another embodiment of the present invention, which is substantially similar to the fourth embodiment with the exception described hereinafter. The main body 31 is formed with teeth 314 for moving the main body 31 by turning the adjusting member 33.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjustable wrench structure, comprising:
a main body, having a first clamping board at one end thereof;
a movable body, having a second clamping board at one end thereof, the moveable body being coupled to the main body; and
an adjusting wheel, connecting the movable body and the main body to adjust a distance between the first clamping board and the second clamping board, the entire adjusting wheel being fitted on the outer side of the wrench to allow oversize design.

2. The adjustable wrench structure as claimed in claim 1, wherein either of the movable body or the main body is formed with teeth and the adjusting member is formed with threads therein, the adjusting member being turned to link the movable body to move with respect to the main body.

3. The adjustable wrench structure as claimed in claim 1, wherein the main body is formed with a slide through for insertion and movement of another end of the movable body.

4. The adjustable wrench structure as claimed in claim 3, wherein either of the movable body and the main body is provided with a retaining member for positioning the adjusting wheel in conjunction with a second retaining member.

5. The adjustable wrench structure as claimed in claim 3, wherein the adjusting wheel is in form of two semiannular rings which are assembled with screws.

6. The adjustable wrench structure as claimed in claim 3, wherein either of the movable body and the main body is provided with two retaining members for confining the adjusting member.

7. The adjustable wrench structure as claimed in claim 3, wherein the main body and the movable body are made in form of a semi-cylinder.

8. The adjustable wrench structure as claimed in claim 3, wherein the first clamping board is in a “>”shape and the second clamping board is in a “<”shape.

9. The adjustable wrench structure as claimed in claim 3, wherein each of the first clamping board and the second clamping board has a flat body.

10. The adjustable wrench structure as claimed in claim 3, further comprising a handle at a distal end thereof.
